(19) United States
(12) Patent Application Publication
(10) Pub. No.: US 2006/0238818 A1
(43) Pub. Date: Oct. 26, 2006

(54) Recording medium for image reproduction and image reproducing method

(75) Inventor: Toshiyuki Machida, Tokyo (JP)

Correspondence Address: BACON & THOMAS, PLLC, 625 SLATERS LANE, FOURTH FLOOR, ALEXANDRIA, VA, 22314, US

(73) Assignee: ATELIER 38 CO., LTD., Tokyo (JP)

(21) Appl. No.: 11/319,636

(22) Filed: Dec. 29, 2005

(30) Foreign Application Priority Data
Apr. 22, 2005 (JP) 2005-125805

(51) Int. Cl. H04N 1/23

(52) U.S. Cl. 358/296

(57) ABSTRACT

A first mode of the present invention relates to a recording medium for image reproduction, specifically, a recording medium obtained by fixing an ink receiving layer containing porous minute particles to the surface of a base material consisting of gypsum. A second mode of the present invention relates to a recording medium for image reproduction, specifically, a recording medium obtained by, after forming a clay layer consisting of pulp (paper) clay on the surface of a base material consisting of gypsum, forming an ink receiving layer containing porous minute particles on the surface of the clay layer. A third mode of the present invention relates to an image reproducing method ensuring that reproduction of a fresco-toned image is easily attainable by giving printing of a digital image to the surface of the ink receiving layer of the recording medium for image reproduction according to the first or the second mode described the above by using an ink jet direct printer involving use of pigment ink.

### BACKGROUND OF THE INVENTION

1. Field of the Invention

This invention relates to a recording medium for image reproduction, more particularly, a recording medium suitably used to reproduce a picture, a photograph and other images in the fashion of fresco-toned image (image close to a fresco) using an ink jet printer, and also, an image reproducing method.

2. Description of the Prior Art

In recent years, reproduction of a digital image obtained by image processing of a picture and a photograph has been carried out by means of giving printing of the above digital image to a recording medium using an ink jet printer.

However, any proposals of a recording medium for reproduction and an image reproducing method both capable of attaining reproduction of an image in the fashion of fresco-toned image have been not made yet.

Ink Jet recording mediums having been proposed as those adaptable to reproduction of the picture etc. using the ink jet printer are as follows, for instance.

That is, in Japanese Patent Laid-open No. 2001-287440, there is described an ink jet recording medium that has a base sheet having, on the surface thereof, more than one ink receiving layer (an acceptance layer) containing, as main components, a pigment and a binder, wherein the ink receiving layer is obtained as that having a certain level or more of a surface roughness.

In Japanese Patent Laid-open No. 2001-293945, there is described an ink jet recording medium that applies, as a base material (a support), a voided oriented film containing, as essential components, crystalline polypropylene resin and dicyclopentadien petroleum resin, wherein the surface of the base material is given in the form of an embossed surface, and further, the base material has an ink receiving layer on the embossed surface.

In Japanese Patent Laid-open No. 2001-096906, there is described an ink jet recording medium that applies, as a base material (a support), a cloth consisting of thread having an average diameter of 200 to 450 μm, wherein the base material has, on one surface thereof, a coated layer, and the surface of an image recording layer is given in the form of a surface that makes an impression of unevenness by specifying a relative-specular glossiness of the image recording layer surface to fall in a certain range, while specifying a smoothness of the image recording layer surface to fall in a certain range.

Each of the recording mediums in the prior arts described the above has the surface having desired unevenness so that an image meeting the object of each of the above recording mediums is obtainable, in which case, however, it is difficult to adapt the above recording mediums to reproduction of an image in the fashion of fresco-toned image of strong appeal, resulting in no attainment to gratification given to devotees of duplicates of pictures and other images.

### SUMMARY OF THE INVENTION

In view of the above problems, the present invention is intended to provide, at low cost, a recording medium for image reproduction, more specifically, a recording medium easily adaptable to reproduction of an image in the fashion of fresco-toned image, and also, to provide an image reproducing method ensuring that reproduction of a fresco-toned image is attainable by using-the above recording medium for image reproduction.

A recording medium for image reproduction in a first mode according to the present invention is characterized by being obtained by fixing an ink receiving layer containing porous minute particles to the surface of a base material consisting of gypsum.

A recording medium for image reproduction in a second mode according to the present invention is characterized by being obtained by, after forming a clay layer consisting of pulp (paper) clay on the surface of a base material consisting of gypsum, fixing an ink receiving layer containing porous minute particles to the surface of the pulp clay layer.

An image reproducing method according to the present invention is characterized in that printing of a digital image is given to the surface of the ink receiving layer of the recording medium for image reproduction in the first or the second mode described the above using an irk jet direct printer involving use of pigment ink.

The recording medium for image reproduction in the first mode according to the present invention allows stabled fixation of ink to be given by the porous minute particle-contained ink receiving layer having got fixed to the surface of the gypsum base material, and besides, ensures that a reproduced image obtained with the ink takes the form of fresco-toned image. Further, use of the gypsum for the base material has the advantage of providing the surface of the base material in the unrestricted form at low cost.

The surface of the gypsum base material may be in the form of a rough surface depending on machining of a mold required at the time of molding.

The recording medium for image reproduction in the second mode according to the present invention allows, in addition to the effects of the recording medium in the above first mode, the clay layer consisting of the pulp clay to strengthen fixedness of the ink receiving layer, and also, ensures that use of the clay layer leads to an increase in impression of unevenness or roughness, thereby enabling reproduction of an image closer to the fresco to be attained.

The image reproducing method according to the present invention is characterized in that printing of the digital image is given to the surface of the ink receiving layer of the recording medium for image reproduction according to the first or the second mode of the present invention using the ink jet direct printer involving use of the pigment ink, and thus has the advantage of being capable of attaining reproduction of the fresco-toned image in large quantities at low cost.

Further, the reproduced image is resistant to weather enough to permit contribution toward prevention of discoloration of the reproduced image.

### BRIEF DESCRIPTION OF THE DRAWINGS

The foregoing and other objects and features of the invention will become apparent from the following description of the embodiments of the invention with reference to the accompanying drawings, in which:

FIG. 1 is a partial sectional view showing a first embodiment of a recording medium for image reproduction according to the present invention; and

FIG. 2 is a partial sectional view showing a second embodiment of the recording medium for image reproduction according to the present invention.

### DETAILED DESCRIPTION OF THE INVENTION

### First Embodiment (Corresponding to Claim 1)

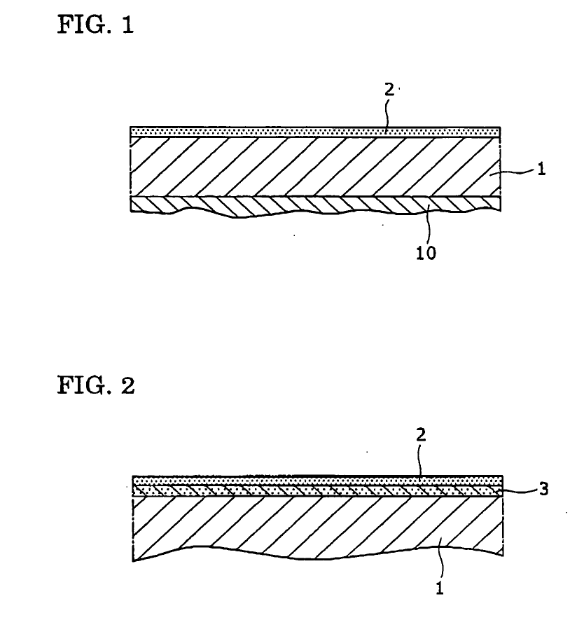

FIG. 1 is a partial sectional view showing a recording medium for image reproduction in a first embodiment according to the present invention.

Reference numeral 1 denotes a plate-shaped base material obtained by being molded with gypsum, in which case, it is allowable to fix a reinforcing material 10 made up of a hard plastic or wood material or other hard materials to the back surface side of the base material 1. Preferably, the reinforcing material 10 in the form of a tray is used to bring into a condition in which the base material 10 may project from a peripheral edge of the reinforcing material in the form of the tray toward the surface side.

In the first embodiment, while the surface (an upper surface in FIG. 1) of the base material 1 is in the form of a horizontal surface, it is allowable to provide the surface of the base material in the form of an uneven surface or a concave or convex surface.

The base material 1 has, fixedly on the surface (a side for image reproduction) thereof, an ink receiving layer 2 containing, as main components, porous minute particles. The ink receiving layer 2 is specified as a layer adapted to absorptive fixation of ink for ink jet printing to the base material 1, and thus, needs to be fixed to the base material 1 with the porous minute particles bound by a binder used for a cloth.

Available porous minute particles include, for instance, silica, alumina, calcium carbonate, magnesium carbonate, magnesium oxide, talk and clay etc. that are used individually or as a mixture of two or more components. According to an experiment, use of natural or synthetic silica has proven to be most preferable over the range of the above porous minute particles.

An average particle size of the porous minute particles is preferably required to be in the range of 3 to 30 μm. Use of the porous minute particles as small as less than 0.3 μm in average particle size causes a lack of absorbability (fixation of ink) of the ink. Conversely, use of the porous minute particles as large as more than 30 μm in average particle size makes it difficult to get the ink receiving layer 2 fixed in the form of a uniform layer to the base material 1, and besides, results in no formation of sharp lines at the time when printing of the image is done according to a procedure described later. The optimum average particle size of the porous minute particles is in the range of 0.7 to 10 μm.

A pore capacity of the porous minute particles is preferably required to be in the range of 0.5 to 2.00 ml/g with consideration of the fixation of the ink.

No restriction is placed on the binder, so long as the binder is that used for the cloth, For instance, available binders include acrylic resin, urethane resin, polyvinyl alcohol and ethylene-vinyl acetate copolymer etc. When the silica is used as the porous minute particles, use of the binder containing the urethane resin is preferably required, more preferably, use of the binder containing a mixture of acrylic-styrene resin and a petroleum solvent is required.

While a mixing ratio of the binder to the porous minute particles differs depending on the quality, the average particle size and the pore capacity etc. of the porous minute particles, the amount of the binder is generally in the range of 50 to 400 parts by weight per 100 parts by weight of the porous minute particles, A balance of the mixing ratio of the binder to the porous minute particles is taken into consideration as follows. That is, use of too much porous minute particles causes the ink to easily peel off, although it permits contribution toward an improvement in color development (vividness of each color) of the ink at the time when printing of the image is done according to the procedure described later. Conversely, use of too much binder leads to degradations in the color development of the ink. Thus, when the acrylic-styrene resin is used as the binder with the silica used as the porous minute particles, the amount of the binder is preferably required to be in the range of 100 to 350 parts by weight per 100 parts by weight of the silica.

For the purpose of fixing the ink receiving layer 2 as described the above to the surface of the base material 1, the following means is taken. That is, after preparation of a mixture in the form of solution by dispersing porous minute particles into an appropriate solvent together with the binder, or if required, a mixture in the form of diluted solution by adding a proper amount of water to the mixture in the form of solution described the above, the mixture is applied to the surface of the base material 1, and is followed by air drying at room temperature.

Application of the mixture to the base material 1 is carried out using a brush, a roller (a sponge roller) or other general application means.

Use of a compound obtained by adding coloring matters and/or one or two or more kinds of pigments or metal powder to the mixture in the form of solution containing the binder and the porous minute particles ensures that the ink receiving layer 2 shows a desired ground color, thereby permitting contribution toward an improvement in variety of creative expressions (an increase in latitude of expressions) supposed to be given on the occasion of reproduction of the image.

For reproduction of the image, printing of the digital image obtained from pictures and calligraphic works and/or photographs through image processing is given to the surface of the ink receiving layer 2 of the recording medium for image reproduction according to the first embodiment by using an ink jet direct printer (a three-dimensional printer) used for printing of thick matters with pigment ink (water or oil ink).

Following the printing, it is necessary to subject the printed surface to air drying in a short period of time.

The reproduced image obtained as described the above results in an image that is so rich with an impression of a fresco-toned image close to the fresco as to be supposed to fully give gratification to the devotees of the duplicates of pictures and other images.

Further, in the case where preservation of the reproduced image takes place indoors under a normal condition, there is no possibility that discoloration of the reproduced image is caused.

### Second Embodiment (Corresponding to Claim 2)

As shown in FIG. 2, the recording medium for image reproduction is obtained by, after forming a clay layer 3 consisting of pulp clay on the surface of the plate-shaped base material 1 consisting of gypsum, fixing the same ink receiving layer 2 as that in the first embodiment to the surface of the clay layer 3. It is allowable to provide the reinforcing material on the back surface side of the base material 1, like the first embodiment.

In formation of the clay layer 3, the following means is taken. That is, after preparation of a soft pasty mixture (in the pulpy form) by stirring a mixture obtained by adding a proper amount of water to clay, the soft pasty mixture is applied to the surface of the base material 1 using the brush, the sponge roller or other application means, and is followed by drying. During the time stirring of the mixture of the water and the clay takes place, it is preferably necessary to cut fibers contained in the clay into pieces by use of a mixer etc., for instance.

The recording medium for image reproduction in the second embodiment allows the clay layer 3 consisting of the pulp clay to strengthen fixedness of the ink receiving layer 2, and also, ensures that use of the clay layer 3 leads to an increase in impression of unevenness or roughness, thereby enabling reproduction of an image closer to the fresco to be attained.

Use of a recording medium obtained by giving coloring to the above soft pasty clay as desired leads to an increase in latitude of expressions.

Other configurations, operations and effects of the recording medium of the second embodiment are the same as those of the recording medium of the first embodiment, and hence, their descriptions will be omitted.

Some specific examples of manufacturing of the recording medium and production of the duplicate will now be described.

### Example 1 of Manufacturing of the Recording Medium

Synthetic silica (by the trade name of “Sylysia” manufactured by FUJI SILYSIA CHEMICAL LTD) having an average particle size of 3 μm, a pore capacity of 1.25 ml/g and an average pore diameter of 17 nm was used as the porous minute particles.

A binder (manufactured by MINORU GROUP CO., LTD) obtained in the form of water-base emulsion by mixing a petroleum solvent into acrylic-styrene resin was used as the binder.

The ink receiving layer 2 having an average thickness of about 100 μm was formed on the surface of the base material 1 consisting of gypsum by taking the steps of, after preparation of a mixture by adding 2.5 parts by weight of binder emulsion and 5 parts by weight of water to 1 part by weight of the porous minute particles, applying the mixture in the form of a uniform thin layer to the surface of the base material 1, and then subjecting the layer of the mixture to drying.

### Example 2 of Manufacturing of the Recording Medium

The clay layer 3 was formed by taking the steps of, after preparation of a soft pasty mixture by putting a mixture of 1 part by weight of water and 1 part by weight of pulp clay (by the trade name of star clay) in a mixer to subject the fibers contained in the clay to cutting into pieces, applying the soft pasty mixture to the surface of the base material 1 consisting of gypsum, and then subjecting the layer of the soft pasty mixture to drying.

Then, the same steps of procedure as those in the example 1 of manufacturing were taken to fix the ink receiving layer 2 to the surface of the clay layer 3.

### Example of Production of the Duplicate

Printing of a preliminary set-up digital image was given, with pigment ink (water pigment ink manufactured by EPSON LTD), to the surface of the ink receiving layer 2 of each of the obtained image recording mediums for image reproduction according to the examples 1 and 2 by using a three-dimensional ink jet printer (by the trade name of MMP-1300 manufactured by MASTERMIND CO., LTD) for printing of the thick matters.

The produced duplicate as described the above ensures that a printed surface thereof is clear and rich with a three-dimensional impression, and is thus obtained in the fashion of fresco-toned image close to the fresco.

1. A recording medium for image reproduction, comprising:
a base material consisting of gypsum; and an ink receiving layer containing porous minute particles, wherein said ink receiving layer is fixed to the surface of said base material.

2. A recording medium for image reproduction, comprising:
a base material consisting of gypsum; a clay layer consisting of pulp (paper) clay and formed on the surface of said base material; and an ink receiving layer containing porous minute particles, wherein said ink receiving layer is fixed to the surface of said pulp clay layer.

3. The recording medium for image reproduction according to claim 2, wherein in formation of said clay layer on the surface of the base material, application of a mixture of water and the pulp clay to the surface of the base material takes place with in-pulp clay fibers cut into pieces.

4. The recording medium for image reproduction according to claim 1, wherein the porous minute particles contained in said ink receiving layer are given in the bound form by a binder used for a cloth.

5. The recording medium for image reproduction according to claim 4, wherein said ink receiving layer contains the porous minute particles consisting of silica having an average particle size of 0.3 to 30 μm and a pore capacity of 0.5 to 2.00 ml/g and the binder consisting of acrylic resin.

6. An image reproducing method comprising the step of, by using an ink jet direct printer involving use of pigment ink, giving printing of a digital image to the surface of said ink receiving layer of the recording medium for image reproduction according to claim 1.

7. The recording medium for image reproduction according to claim 2, wherein the porous minute particles contained in said ink receiving layer are given in the bound form by a binder used for a cloth.

8. The recording medium for image reproduction according to claim 3, wherein the porous minute particles contained in said ink receiving layer are given in the bound form by a binder used for a cloth.

9. An image reproducing method comprising the step of, by using an ink jet direct printer involving use of pigment ink, giving printing of a digital image to the surface of said ink receiving layer of the recording medium for image reproduction according to claim 2.

10. An image reproducing method comprising the step of, by using an ink jet direct printer involving use of pigment ink, giving printing of a digital image to the surface of said ink receiving layer of the recording medium for image reproduction according to claim 3.

11. An image reproducing method comprising the step of, by using an ink jet direct printer involving use of pigment ink, giving printing of a digital image to the surface of said ink receiving layer of the recording medium for image reproduction according to claim 4.

12. An image reproducing method comprising the step of, by using an ink jet direct printer involving use of pigment ink, giving printing of a digital image to the surface of said ink receiving layer of the recording medium for image reproduction according to claim 5.
